(19) United States
(12) Patent Application Publication
(10) Pub. No.: US 2026/0249385 A1
(43) Pub. Date: Aug. 27, 2026

(54) ABNORMALITY DETERMINATION DEVICE, LASER MACHINING TOOL, AND ABNORMALITY DETERMINATION METHOD

(71) Applicant: Murata Machinery, Ltd., Kyoto-shi, Kyoto (JP)

(72) Inventor: Shogo Hashimoto, Kyoto-shi, Kyoto (JP)

(73) Assignee: Murata Machinery, Ltd., Kyoto-shi, Kyoto (JP)

(21) Appl. No.: 18/993,839

(22) PCT Filed: Jul. 3, 2023
(86) PCT No.: PCT/JP2023/024579

§ 371 Date: Jan. 13, 2025

(30) Foreign Application Priority Data
Jul. 14, 2022 (JP) 2022-113303

(51) Int. Cl. B23K 26/03; B23K 26/064

(52) U.S. Cl. CPC B23K 26/032; B23K 26/0643; B23K 26/0648

(57) ABSTRACT

An abnormality determination device, a laser machining tool, and an abnormality determination method capable of accurately determining an abnormality in machining being performed on a workpiece are disclosed.

An abnormality determination device that determines a machining abnormality of a workpiece W includes an accumulator that accumulates, when a processor performs normal machining on the workpiece W while moving relative to the workpiece W as a mover moves, state quantities detected by a sensor in association with the movement related value acquired by an acquirer, a calculator that calculates a normal range of the state quantities for each movement related value on the basis of information accumulated in the accumulator, and a determiner that determines after the normal range is calculated, based on a calculation result of the calculator, whether or not a state quantity detected by the sensor is within the normal range.

### CROSS REFERENCE TO RELATED APPLICATIONS

This application is a U.S. national stage filing under 35 U.S.C. § 371 of International Application No. PCT/JP2023/024579, filed Jul. 3, 2023, which claims priority to Japanese Patent Application No. 2022-113303, filed Jul. 14, 2022, each of which is incorporated herein by reference in its entirety.

### TECHNICAL FIELD

This disclosure relates to an abnormality determination device, a laser machining tool, and an abnormality determination method.

### BACKGROUND

A laser machining tool performs laser machining such as cutting on a workpiece by irradiating the workpiece with a laser beam while moving the laser head relative to the workpiece. In a laser machining tool, it is necessary to appropriately perform laser machining on a workpiece. Thus, in laser machining, it has been proposed that when excellent machining quality is achieved during test machining or actual machining, the operator stores the laser output reference value through a predetermined operation, and laser machining is performed based on this value (for example, see Japanese Examined Patent Application Publication No. H07-61553).

In machining devices such as laser machining tools, a sensor may be installed to detect state quantities related to the workpiece machining being performed by the machining device to manage machining quality. The state quantities detected by the sensor are used to determine whether or not there is an abnormality in machining being performed on the workpiece depending on whether or not it falls outside a preliminarily set state quantity normal range (hereinafter, referred to as “normal range”). The normal range may be set more broadly (relaxedly) depending on the operating status of the machining device. However, when the normal range is too broad, there may be instances where a state that should be determined as abnormal is not determined as such. Thus, to improve the accuracy in determining an abnormality in machining, it is desirable to acquire an even more appropriate normal range. In Japanese Examined Patent Application Publication No. H07-61553 mentioned above, laser machining is performed solely based on the laser output reference value, which does not address the aforementioned problem.

It could therefore be helpful to provide an abnormality determination device, a laser machining tool, and an abnormality determination method capable of accurately determining an abnormality in machining being performed on a workpiece.

### SUMMARY

An abnormality determination device is an abnormality determination device that determines a machining abnormality of a workpiece in a machining device having a mover that moves relative to a workpiece, and a processor that is provided on the mover and performs machining on the workpiece while moving together with the mover relative to the workpiece, the abnormality determination device including a sensor that is provided on the mover and detects state quantities related to machining of the workpiece performed by the machining device while moving together with the mover relative to the workpiece, an acquirer that acquires movement related values related to a movement of the mover, an accumulator that accumulates the state quantities detected by the sensor in association with the movement related values acquired by the acquirer when the processor performs normal machining on the workpiece while moving relative to the workpiece as the mover moves, a calculator that calculates, based on information accumulated in the accumulator, a normal range of the state quantities for each movement related value, and a determiner that determines, based on a calculation result of the calculator, whether or not a state quantity detected by the sensor is within the normal range when, after the normal range is calculated, the processor performs machining on the workpiece while moving relative to the workpiece as the mover moves.

A laser machining tool includes a laser head that moves relative to a workpiece, a laser emitter that is provided in the laser head and emits a laser beam onto the workpiece to perform machining on the workpiece while moving together with the laser head relative to the workpiece, and an abnormality determination device that determines a machining abnormality of the workpiece. The abnormality determination device includes a sensor that is provided in the laser head and detects state quantities of the laser machining tool while moving together with the laser head relative to the workpiece, an acquirer that acquires movement related values related to a movement of the laser head, an accumulator that accumulates, when the laser emitter performs normal machining on the workpiece while moving relative to the workpiece as the laser head moves, the state quantities detected by the sensor in association with the movement related values acquired by the acquirer, a calculator that calculates, based on information accumulated in the accumulator, a normal range of the state quantities for each movement related value, and a determiner that determines, based on a calculation result of the calculator, whether or not a state quantity detected by the sensor is within the normal range when, after the normal range is calculated, the laser head performs machining on the workpiece while moving relative to the workpiece.

An abnormality determination method n is a method for determining an machining abnormality of a workpiece in a machining device having a mover that moves relative to a workpiece, and a processor that is provided on the mover and performs machining on the workpiece while moving together with the mover relative to the workpiece, the method including detecting, when the processor performs normal machining on the workpiece while moving relative to the workpiece as the mover moves, the state quantities of machining device by the sensor that moves together with the mover relative to the workpiece, acquiring movement related values related to a movement of the mover, accumulating the state quantities detected by the sensor in association with the movement related values acquired by the acquirer, calculating, based on information accumulated in the accumulator, a normal range of the state quantities by the calculator for each movement related value, and determining, based on a calculation result of the calculator, whether or not a state quantity detected by the sensor is within the normal range when, after the normal range is calculated, the processor performs machining on the workpiece while moving relative to the workpiece as the mover moves.

The abnormality determination device, the laser machining tool, and the abnormality determination method according to the above aspects set the normal range in consideration of the movement related values related to the movement of the mover, and it is thus possible to accurately determine an abnormality in machining being performed on a workpiece.

In the abnormality determination device of the above aspect, the movement related values may include movement speeds of the mover. With this configuration, the normal range is set in consideration of the movement speeds, and it is thus possible to accurately determine an abnormality in machining being performed on a workpiece. In the abnormality determination device of the above aspect, the movement related values may include movement directions of the mover. With this configuration, the normal range is set in consideration of the movement directions, and it is thus possible to accurately determine an abnormality in machining being performed on a workpiece. In the abnormality determination device of the above aspect, the processor may be a laser emitter of the laser head that emits a laser beam, and the processor may be a laser emitter of the laser head that emits a laser beam. With this configuration, it is possible to accurately determine an abnormality in laser machining being performed on a workpiece in the laser machining tool.

In the abnormality determination device of the above aspect, based on information accumulated in the accumulator, the calculator may calculate a table indicating the normal range for each movement related value, and based on the table, the determiner may determine whether or not a state quantity detected by the sensor is within the normal range. Based on information accumulated in the accumulator, the calculator may derive an arithmetic expression for calculating the normal range for each movement related value, and based on the arithmetic expression, the determiner may determine whether or not a state quantity detected by the sensor is within the normal range. With this configuration, it is possible to accurately determine an abnormality in machining being performed on a workpiece, using the table or the arithmetic expression. In the abnormality determination device of the above aspect, the sensor may detect, as a state quantity, at least one of a quantity of light, a temperature, a sound, and an image analysis result. With this configuration, based on at least one of a quantity of light, a temperature, a sound, and an image analysis result, it is possible to detect a machining abnormality. The laser machining tool of the above aspect may include a head control device that stops machining of the workpiece if the determiner determines the state quantity detected by the sensor as being outside the normal range. With this configuration, it is possible to automatically stop machining being performed on a workpiece if a machining abnormality occurs. The laser machining tool of the above aspect may include a head control device that changes a movement speed of the laser head until the state quantity detected by the sensor falls within the normal range if the determiner determines the state quantity detected by the sensor as being outside the normal range. With this configuration, if an abnormality occurs in machining being performed on a workpiece, it is possible to handle the abnormality without stopping the machining of the workpiece, thus suppressing a reduction in productivity.

### BRIEF DESCRIPTION OF THE DRAWINGS

FIG. 1 is a diagram showing an example of a laser machining tool and an abnormality determination device.

FIG. 2 is a diagram showing an example of a configuration of a laser head.

FIG. 3 is a diagram showing an example of functional units of an abnormality determiner.

FIG. 4A is a diagram showing a first example of a table.

FIG. 4B is a diagram showing the first example of the table.

FIG. 5A is a diagram showing a second example of the table.

FIG. 5B is a diagram showing the second example of the table.

FIG. 5C is a diagram showing the second example of the table.

FIG. 6 is a diagram showing a method of dividing a speed setting range.

FIG. 7A is a diagram for describing a method of finding a state quantity normal range from a normal range calculation table.

FIG. 7B is a diagram for describing a method of finding a state quantity normal range from the normal range calculation table.

FIG. 7C is a diagram for describing a method of finding a state quantity normal range from the normal range calculation table.

FIG. 8 is a flow chart of an abnormality determination method.

FIG. 9 is a diagram showing a first example of a test machining shape.

FIG. 10 is a second example of the test machining shape.

FIG. 11 is a diagram showing a problem with abnormality determination in a laser machining tool according to a comparative example.

FIG. 12 is a diagram showing relationships between state quantities obtained in laser machining and both movement speed and movement direction according to the comparative example.

FIG. 13 is a diagram showing a transfer function.

### DESCRIPTION OF REFERENCE SIGNS

1: Laser machining tool
2: Machining device
3: Abnormality determination device
12: Laser head
30: Sensor
31: Abnormality determiner
40: Acquirer
41: Accumulator
42: Calculator
43: Determiner
44: Outputter

### DETAILED DESCRIPTION

Hereinafter, my devices, tools and methods will be described through an example. However, this disclosure as defined in the claims is not limited to the following example, and not all combinations of features described in the example are essential. In the drawings, the same or similar members are denoted by the same reference signs, and redundant descriptions may be omitted. The shapes and sizes of elements in the drawings may be exaggerated for clarity, and the dimensions and shapes may differ from the actual product.

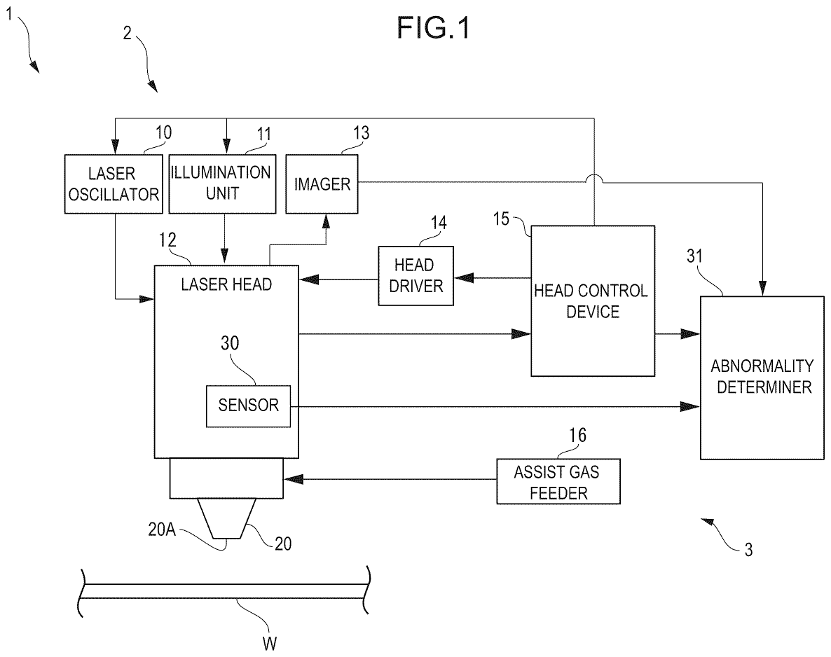

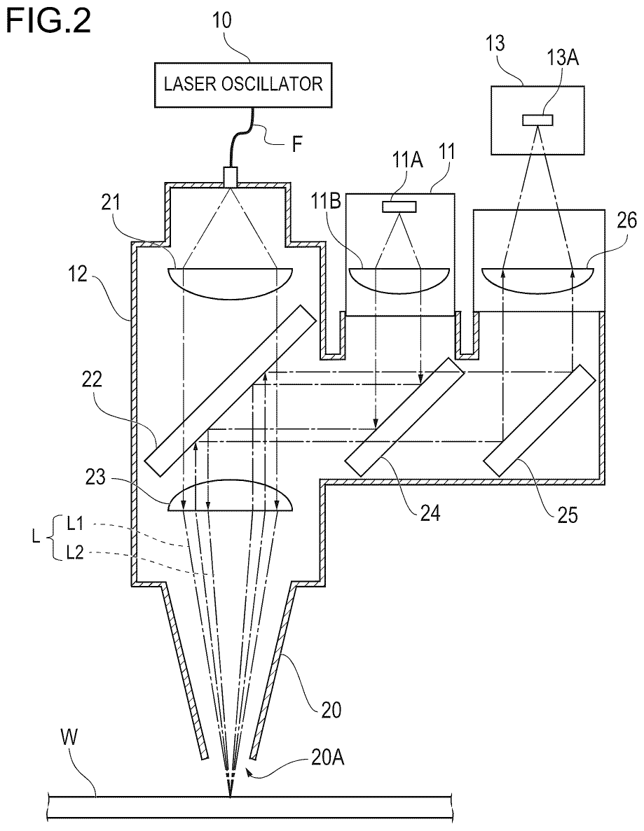

FIG. 1 is a diagram showing an example of a laser machining tool 1 and an abnormality determination device 3. FIG. 2 is a diagram showing an example of a configuration of a laser head 12 included in the laser machining tool 1 of FIG. 1. The laser machining tool 1 is a device that emits a laser beam L to perform laser machining such as cutting and marking on a machining target workpiece W. The laser machining tool 1 includes a machining device 2 and an abnormality determination device 3. The machining device 2 includes a laser oscillator 10, an illumination unit 11, a laser head 12, an imager 13, a head driver 14, a head control device 15, and an assist gas feeder 16.

The laser oscillator 10 generates a machining laser beam L1. For example, the machining laser beam is an infrared laser beam. The laser oscillator 10 is connected to the laser head 12 via an optical fiber F. The optical fiber F introduces the machining laser beam L1 output from the laser oscillator 10 to the laser head 12. The illumination unit 11 includes a laser array 11A and a collimator 11B. The laser array 11A emits an illumination laser beam L2 having a wavelength different from that of the machining laser beam L1. The collimator 11B is provided at an incidence position of the illumination laser beam L2 from the laser array 11A, and converts the illumination laser beam L2 incident from the laser array 11A into a collimated light.

The laser head 12 irradiates the workpiece W with the laser beam L (machining laser beam L1 and illumination laser beam L2) from a nozzle 20. The laser head 12 is provided to be movable relative to the workpiece W in the X direction, the Y direction, and the Z direction. The laser head 12 performs cutting machining by irradiating the machining laser beam L1 along a cutting line formed in the workpiece W while moving relative to the workpiece W. The laser head 12 is an example of the “mover”.

As shown in FIG. 2, the laser head 12 includes a nozzle 20, a collimator 21, a beam splitter 22, a condenser lens 23, a half mirror 24, a wavelength selective filter 25, and an imaging lens 26. The nozzle 20 is attached below (on the −Z side) of the laser head 12. The nozzle 20 is oriented downwards. The nozzle 20 has an emission opening 20A.

The machining laser beam L1 and the illumination laser beam L2 are irradiated downward from the emission opening 20A. The nozzle 20 is connected to the assist gas feeder 16 via a gas supply pipe or the like. The nozzle 20 directs an assist gas (for example, nitrogen gas) from the assist gas feeder 16 toward a region to be irradiated with the laser beam L1 to supply it to the workpiece W. The nozzle 20 is an example of the processor and corresponds to the laser emitter. The illumination unit 11, the imager 13, the beam splitter 22, the half mirror 24, the wavelength selective filter 25, the imaging lens 26, and other components may not necessarily be provided in a configuration in which a sensor 30 detects quantities of light, temperatures, sounds, or the like (a configuration in which state quantities other than image analysis results are detected).

The collimator 21 is provided so that the incident side focal point of the machining laser beam L1 coincides with the position of an end of the optical fiber F, and converts the machining laser beam L1 output from the laser oscillator 10 into a collimated light. The beam splitter 22 is provided at an incidence position of the machining laser beam L1 passing through the collimator 21 and transmits the machining laser beam L1. The condenser lens 23 that reflects the illumination laser beam L2 is provided at an incidence position of the machining laser beam L1 from the beam splitter 22, and focuses the machining laser beam L1 incident thereon. The condenser lens 23 can be moved along an optical axis by an optical system driver (not shown in the drawings). The focal point on the workpiece W side is adjusted by this optical system driver.

The half mirror 24 is provided at an incidence position of the illumination laser beam L2 passing through the collimator 11B, and partially reflects and partially transmits the illumination laser beam L2. The illumination laser beam L2 reflected by the half mirror 24 is reflected by the beam splitter 22. The condenser lens 23 focuses the illumination laser beam L2 reflected by the beam splitter 22. The region on the workpiece W irradiated with the illumination laser beam L2 is set to include the region on the workpiece W irradiated with the machining laser beam L1.

The return light from the workpiece W passes through the condenser lens 23 and enters the beam splitter 22. The return light includes light of the illumination laser beam L2 reflected and scattered by the workpiece W and light of the machining laser beam L1 reflected by the workpiece W. The light originating from the illumination laser beam L2 is reflected by the beam splitter 22 and enters the half mirror 24. Similarly, the light originating from the machining laser beam L1 is reflected by the beam splitter 22 and enters the half mirror 24. When molten metal of the workpiece W is deposited on a cut surface of the workpiece W or the like, returned light includes light within the infrared to near-infrared wavelength range emitted from the molten metal. The light originating from the molten metal is reflected by the beam splitter 22 and enters the half mirror 24.

The wavelength selective filter 25 is, for example, a dichroic mirror, a notch filter, or the like. The return light that has entered the half mirror 24 passes through the half mirror 24 and enters the wavelength selective filter 25. The light originating from the illumination laser beam L2 is reflected by the wavelength selective filter 25 and enters the imaging lens 26. On the other hand, the light originating from the machining laser beam L1 is transmitted through the wavelength selective filter 25. The imaging lens 26 focuses the light reflected by the wavelength selective filter 25 onto the imager 13.

The imager 13 is provided on the laser head 12. The imager 13 is a device that captures an image of the region irradiated with the machining laser beam L1. The imager 13 includes an imaging element 13A. The imaging element 13A is an image sensor that detects return light of the illumination of the illumination laser beam L2 that is reflected and scattered by the workpiece W, and generates image data. The imager 13 transmits image data generated by the imaging element 13A to the head control device 15.

The head driver 14 is controlled by the head control device 15 and moves the laser head 12 in each of the X, Y, and Z directions. The head driver 14 has, for example, a gantry that is movable in the X direction, a slider that is movable in the Y direction relative to the gantry, and an elevator that is movable in the Z direction relative to the slider. It should be noted that the head driver 14 is not limited to the above configuration, and may be implemented with another configuration such as a robot arm.

The head control device 15 controls the head driver 14 to thereby control the movement of the laser head 12. For example, the head control device 15 acquires the position information of the laser head 12 at a predetermined cycle, and based on the acquired position information, controls the head driver 14 to thereby control the movement of the laser head 12. Based on the position information of the laser head 12, the head control device 15 finds movement related values, which are values related to the movement of the laser head 12. The movement related values are, for example, the movement speeds and/or the movement directions of the laser head 12. The movement directions are machining directions of laser machining. The head control device 15 controls the head driver 14 so that the found movement related values are preliminarily set values. The head control device 15 outputs the found movement related values to the abnormality determination device 3.

The assist gas feeder 16 is connected to the laser head 12. The assist gas feeder 16 is a device that feeds an assist gas into the nozzle 20. The assist gas is used in laser machining to remove molten material. The supply source of the assist gas may be, for example, a gas cylinder or a supply line in a factory. As the assist gas, for example, nitrogen gas, air, a mixture of nitrogen and oxygen, or the like is used.

The abnormality determination device 3 may have an image processor (not shown in the drawings) that generates, based on the image data generated by the imaging element 13A, machining-state-related data. For example, as the machining-state-related data, the image processor may, for example, generate data indicating a kerf width, create numerical information indicating the combustion state, such as the behavior of the molten metal in the workpiece W, or may do both. The machining-state-related data may be an example of the image analysis result mentioned above. The abnormality determination device 3 determines an abnormality in machining being performed on the workpiece W in the machining device 2. The abnormality determination device 3 includes a sensor 30 and an abnormality determiner 31.

The sensor 30 is provided on the laser head 12. The sensor 30 is, for example, integrally provided on the laser head 12 and configured to move in the same manner as that in which the laser head 12 moves. The sensor 30 may be provided in the interior of the laser head 12. The sensor 30 detects state quantities X related to the machining of the workpiece W performed by the machining device 2 while moving together with the laser head 12 relative to the workpiece W as the laser head 12 moves. The state quantities X are one or more pieces of data for the abnormality determiner 31 to determine whether the machining device 2 is in the normal state or in the abnormal state, and is a value that directly or indirectly indicates the state of the machining device 2. The sensor 30 is an example of the “sensor”. For example, the “sensor” detects, as a state quantity X, at least one of a quantity of light, a temperature, a sound, and an image analysis result.

As an example, the “sensor” may include any one or two or more of sensors listed below. In other words, the state quantities X may be sensor values detected by one or more sensors listed below.
(a) A temperature sensor that detects heat generated by the condenser lens 23 for converging and diffusing laser beam.
(b) A light quantity sensor that detects the quantity of light of reflected light of the machining laser beam L1.
(c) A sound sensor that detects sounds around the laser head 12.
(d) An image sensor that monitors, based on images of the area around the machining point, the size of the cutting groove and the behavior of the molten metal.

When the above sensor is the sensor exemplified in (a), (b), or (c), the above sensor corresponds to the sensor 30. The illumination unit 11, the imager 13 and the image processor are not essential components for implementing the device. On the other hand, when the sensor is the sensor (d) mentioned above, the sensor corresponds to the illumination unit 11, the imager 13, and the image processor described above. The sensor 30 exemplified in FIG. 1 is not an essential component for implementing the device. When the above sensor corresponds to the lighting unit 11, the imager 13, and the image processor mentioned above, the abnormality determination device 3 includes, as the sensor, the lighting unit 11, the imager 13 and the above image processor, for example. The above image processor may be included in the abnormality determiner 31, or may be a device other than the abnormality determiner 31. The device other than the abnormality determiner 31 may be, for example, the imager 13. In the following example, for convenience of description, an instance where the above sensor is the sensor 30 will be described as an example.

The abnormality determiner 31 is, for example, an information processing device such as a computer. The abnormality determiner 31 is connected to the head control device 15 and can exchange information with it. The abnormality determiner 31 is connected to the sensor 30. Based on a state quantity X detected by the sensor 30, the abnormality determiner 31 determines an abnormality in machining being performed on the workpiece W in the machining device 2.

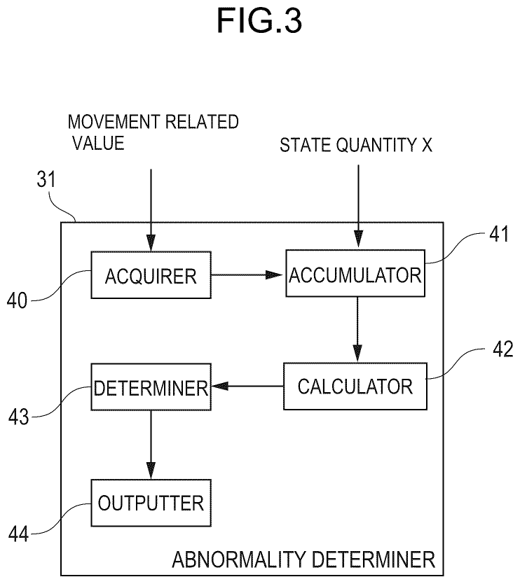

FIG. 3 is a diagram showing an example of functional units of the abnormality determiner 31. As shown in FIG. 3, the abnormality determiner 31 includes an acquirer 40, an accumulator 41, a calculator 42, a determiner 43, and an outputter 44. These components are implemented by, for example, a hardware processor such as a CPU (Central Processing Unit) executing a program (software program). Some or all of these components may be implemented by hardware components (including circuitries thereof) such as an LSI (Large Scale Integrated circuit), an ASIC (Application Specific Integrated Circuit), an FPGA (Field-Programmable Gate Array), or a GPU (Graphics Processing Unit), or may be implemented by a combination of software and hardware components.

The program may be preliminarily stored in a storage device such as an HDD (Hard Disk Drive) or flash memory (a storage device with a non-transient storage medium), or may be stored in a removable storage medium (non-transient storage medium) such as a DVD or CD-ROM, and installed in the storage device by inserting the storage medium into a drive device. The storage device may be composed of, for example, an HDD, a flash memory, an EEPROM (Electrically Erasable Programmable Read Only Memory), a ROM (Read Only Memory), or a RAM (Random Access Memory).

The acquirer 40 acquires movement related values related to the movement of the laser head 12. For example, the acquirer 40 acquires the movement related values from the head control device 15. The acquirer 40 may have a communication interface for communicating with the head control device 15, for example.

The accumulator 41 accumulates the state quantities X detected by the sensor 30 in association with the movement related values acquired by the acquirer 40 when normal laser machining (hereinafter, referred to as “test machining) is performed on the workpiece W by irradiating the laser beam from the nozzle while the laser head 12 is moving. In other words, during test machining, the accumulator 41 accumulates the state quantities X detected by the sensor 30 and the movement related values acquired by the acquirer 40 in association with each other at each constant cycle. When the “sensor” is the sensor (d) above, the abnormality determiner 31 may further include the image processor mentioned above as a functional unit. The accumulator 41 acquires image analysis results as the state quantities X from the image processor.

The test machining is a laser machining process performed on a test workpiece W (hereinafter, referred to as “test workpiece”) in a state where no machining abnormality is occurring. For example, the machining conditions for the test machining are adjusted in advance so that the laser machining can be performed without causing excessive burning or a decline in the quality of the machined workpiece due to cutting defects. In this test machining, the operator assesses whether normal laser machining is taking place on the workpiece W by examining the state of actual machining being performed on the workpiece and the state of machined workpiece. With this configuration, the accumulator 41 accumulates test data of information in which the state quantities X and the movement related values during normal laser machining are associated with each other. The state quantities X detected by the sensor 30 during the test machining may be referred to as “state quantities X1” to distinguish them from other state quantities.

Based on the test data of information in which the state quantities X and the movement related values during normal laser machining are associated with each other, which are accumulated in the accumulator, the calculator 42 calculates a normal range of the state quantities X (hereinafter, referred to as “normal range”) for each movement related value. For example, based on the test data accumulated in the accumulator 41, the calculator 42 creates a table 100 that directly or indirectly determines the normal range of the state quantities X for each movement related value. The calculator 42 may create a table 100 for each workpiece W (for each material and thickness of the workpiece W), or may create a table 100 for each machining condition for machining the workpiece W, or may do both. Examples of the machining conditions include the output of the machining laser beam L1, the focal position of the machining laser beam L1 on the workpiece, and the pressure of the assist gas.

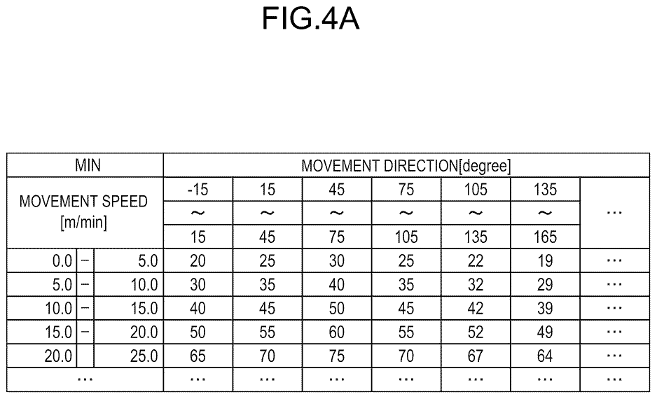

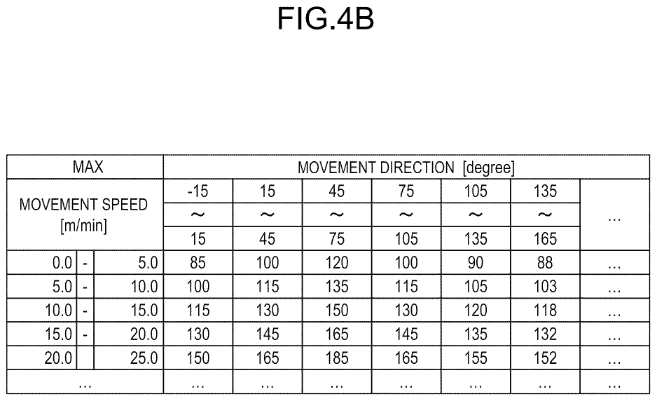

For example, the table 100 is a table in which the normal range of the state quantities X is directly defined in a matrix form for each movement speed and movement direction (hereinafter, referred to as “normal range table”), and may be composed of one or more tables. FIGS. 4A and 4B include diagrams showing first examples of the normal range table. In FIGS. 4A and 4B, as the normal range, the maximum and minimum values of the state quantities X are expressed as absolute values. The normal range tables shown in FIGS. 4A and 4B include a minimum value table (FIG. 4A) and a maximum value table (FIG. 4B). The minimum value table is a table in which the minimum values of the normal range of the state quantities X are defined in a matrix form for each setting range of the movement speed (hereinafter, referred to as “speed setting range”) and each setting range of the movement direction (hereinafter, referred to as “direction setting range”). The maximum value table is a table in which the maximum values of the normal range of the state quantities X are defined in a matrix form for each speed setting range and direction setting range.

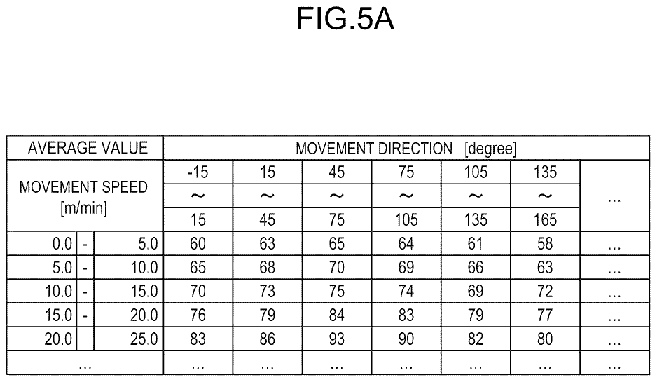

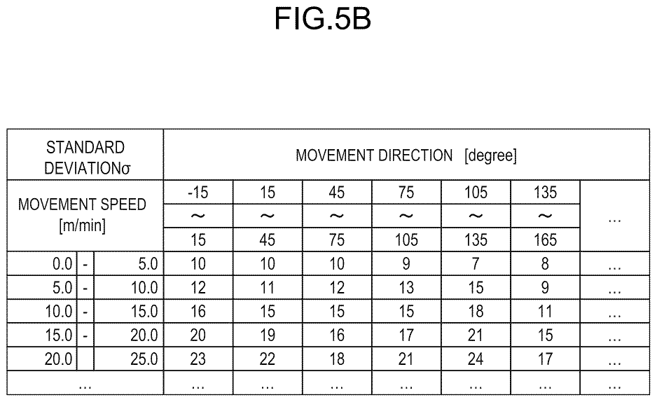

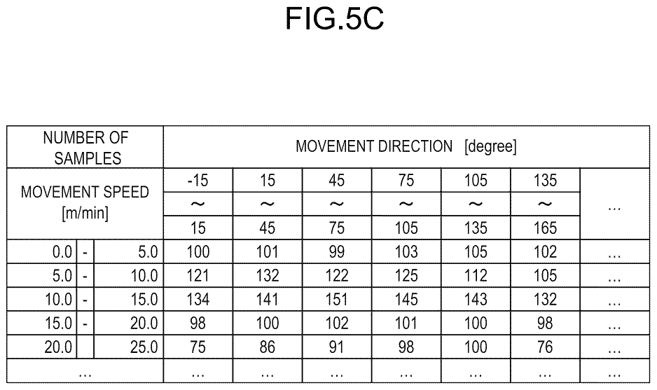

FIGS. 5A-5C include diagrams showing the second example of the table 100. The table 100 may be a table indirectly defining the normal range of the state quantities X for each movement speed and movement direction in a matrix form. For example, as shown in FIGS. 5A-5C, the table 100 is a table in which information (for example, statistical information) for calculating the normal range of the state quantities X for each movement speed and movement direction is defined in a matrix form (hereinafter, referred to as “normal range calculation table”), and may be composed of one or more tables. In the normal range calculation tables shown in FIGS. 5A-5C, the average value, the standard deviation, and the number of samples are used as statistical information. More specifically, the normal range calculation tables shown in FIGS. 5A-5C has an average value table (FIG. 5A), a standard deviation table (FIG. 5B), and a sample number table (FIG. 5C).

The average value table is a table in which the average values of the state quantities X1 for each speed setting range and direction setting range are defined in a matrix form. The standard deviation table is a table in which the standard deviations of the state quantities X1 for each speed setting range and direction setting range are defined in a matrix form. The sample number table is a table in which the number of samples of the state quantities X1 for each speed setting range and direction setting range are defined in a matrix form. The number of samples of the state quantities X1 refers to the number of state quantities X1 used in creating the average value table or the standard deviation table. The statistical information for calculating the normal range is not limited to the average values, standard deviations, and number of samples, and may include other statistical information such as kurtosis and skewness.

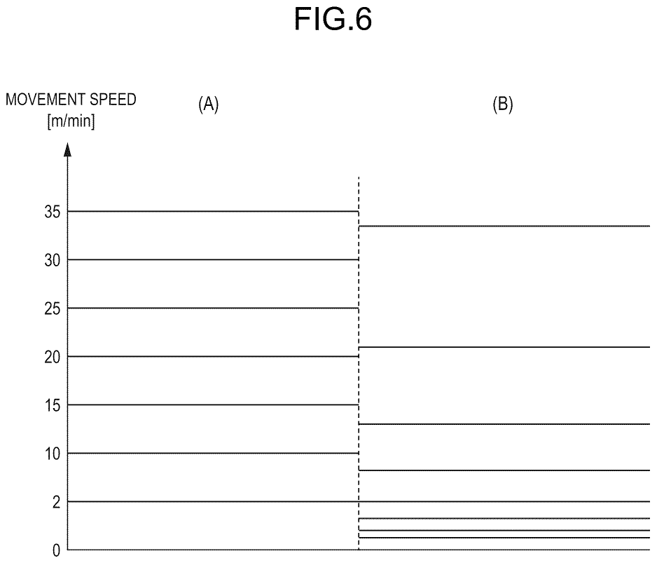

FIG. 6 is a diagram showing a method of dividing a speed setting range. The width of each speed setting range may be the same or may not be the same, and may be set exponentially, for example, so that the width of the speed setting range becomes broader as the speed increases. In other words, when dividing the normal range table into a matrix form for each movement speed and movement direction, it may be divided into linear equal segments as shown in part (A) of FIG. 6, or the speed setting range may be divided exponentially, allowing for a broader range as the speed increases, as shown in part (B) of FIG. 6.

The method of linearly dividing the speed setting range into equal segments is useful where it is necessary to reliably link the normal range to the movement speed when the configuration is simple and the speed is stable at a low speed. The method of exponentially dividing the speed setting range can stabilize abnormality determination criteria because the parameters referenced on the table are less likely to change, even when there are large variations in movement speed in a high-speed region. In other words, the method of exponentially dividing the speed setting range is useful when the variations in movement speed is large in a high-speed region. In the example of part (B) FIG. 6, the same table parameters are referenced for the speed setting range of 21 to 33 m/min. On the other hand, in part (A) of FIG. 6, three table parameters must be referenced for the speed setting range of 21 to 33 m/min.

The determiner 43 determines whether or not the state quantities X detected by the sensor 30 during the actual laser machining (hereinafter, referred to as “actual machining”) on a non-test workpiece W, as the laser head 12 moves, are within the normal range. This abnormality determination is performed based on the table 100, which is an example of the results calculated by the calculator 42. The actual machining is performed after the table 100 is calculated.

For example, during the actual machining, the determiner 43 acquires the state quantities X detected by the sensor 30 and the movement related values of the laser head 12 at each constant cycle. The state quantities X during the actual machining may be referred to as “state quantities X2”. The determiner 43 acquires from the normal range table the normal ranges associated with the movement related values during the actual machining. The determiner 43 then determines at each constant cycle whether or not the state quantities X2 are within the read normal range. If a state quantity X2 falls outside the normal range, the determiner 43 determines that a machining abnormality has occurred. For example, if a state quantity X2 falls outside the normal range even once, the determiner 43 determines that a machining abnormality has occurred.

However, the method is not limited to this configuration, and the determiner 43 may determine a machining abnormality as having occurred if the number of times the state quantities X2 fall outside the normal range exceeds a prescribed number (an integer of 1 or more) during a recent predetermined period. The number of times an abnormality is determined may also be the number of consecutive instances where the state quantities X fall outside the normal range during the recent predetermined period. The prescribed number of times mentioned above may be changeable depending on the machining target workpiece W and the machining conditions.

When using the normal range calculation table for abnormality determination, during the actual machining, the calculator 42 acquires the state quantities X2 detected by the sensor 30 and the movement related values during the actual machining at each constant cycle. The calculator 42 acquires the average values and the standard deviations associated with the movement related values during the actual machining, and based on the acquired average values and standard deviations, creates normal ranges.

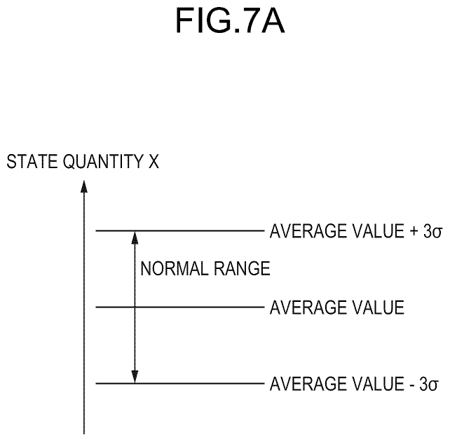

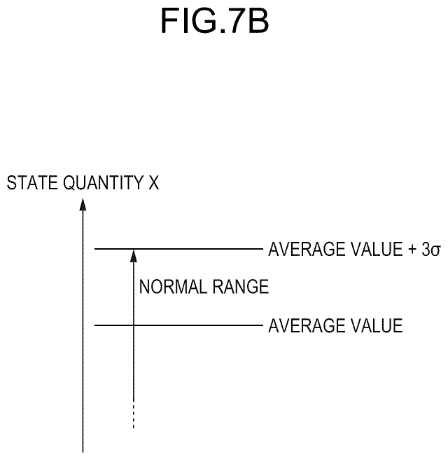

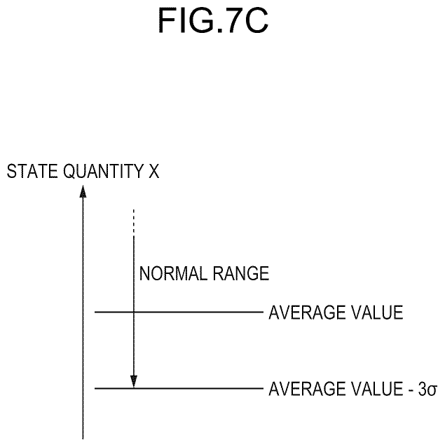

FIGS. 7A-7C include diagrams for describing a method of finding a normal range of the state quantities X from the normal range calculation table. As shown in FIG. 7A, based on the average value and standard deviation acquired from the normal range calculation table, the calculator 42 may calculate a range between the upper limit value shown in Equation (1) and the lower limit value shown in Equation (2) as the normal range. However, the method is not limited to this configuration, and the calculator 42 may calculate a range below the upper limit value shown in Equation (1) as the normal range (FIG. 7B), or may calculate a range above the lower limit value shown in Equation (2) as the normal range (FIG. 7C). The determiner 43 determines whether or not the state quantities X2 fall within the normal range in the same manner as the abnormality determination described above.

$$Upper limit value = average value + α1 \times standard deviation \qquad ( 1 )$$

$$Lower limit value = average value - α1 \times standard deviation \qquad ( 2 )$$

The gain α1 and the gain α2 may both be the same value or may each be different values. The instance shown in the example of FIGS. 7A-7C, α1 and α2 are both “3”. It should be noted that α1 and α2 may each be set based on the kurtosis and skewness.

When the number of samples associated with the movement related values during the actual machining acquired at a certain cycle is extremely small, the determiner 43 may not perform an abnormality determination of the state variable X2 at this cycle, and may perform a process of adjusting the gains, such as increasing each of the values of the gain α1 and the gain α2 from “3” to “4”, in the abnormality determination at this cycle.

The outputter 44 outputs the determination result of the determiner 43. For example, the outputter 44 may output the determination result only when the determiner 43 determines an abnormality as having occurred in machining. For example, the outputter 44 may output the determination result of the determiner 43 to a display device (not shown in the drawings) to thereby cause the display device to display the determination result of the determiner 43. However, the method is not limited to this configuration, and the outputter 44 may output the determination result of the determiner 43 to a communication terminal used by the user via a wired or wireless communication network. The determination result of the determiner 43 may be used for feedback control of machining conditions (such as reducing the movement speed). For example, the outputter 44 may output a signal indicating the determination result to the head control device 15 when the determiner 43 determines an abnormality as having occurred in machining. When the signal indicating the determination result of the determiner 43 is received, the head control device 15 may perform feedback control to change the movement speed until the movement speed falls within the normal range.

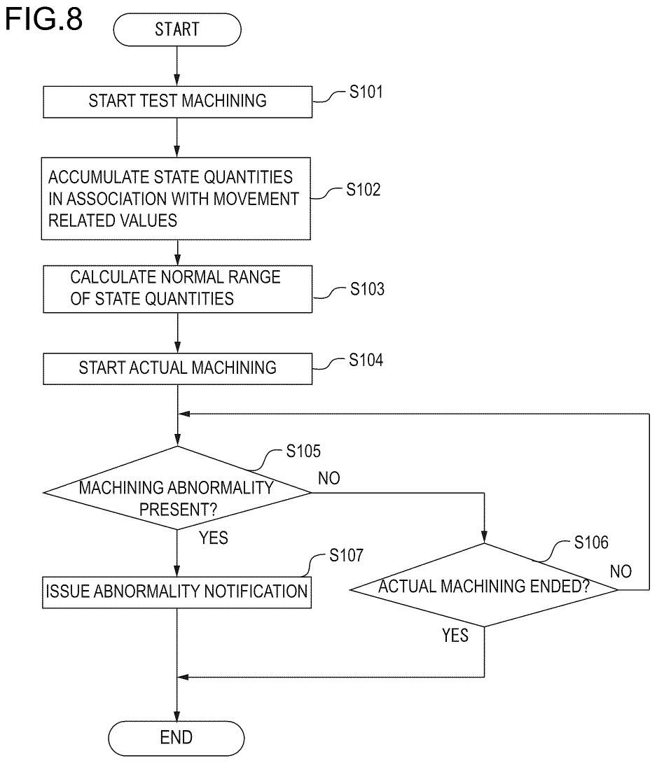

Hereinafter, the flow of an abnormality determination method will be described. FIG. 8 is a flow chart of the abnormality determination method. First, the laser machining tool 1 starts test machining (Step S101). During the test machining, the abnormality determination device 3 accumulates the state quantities X detected by the sensor 30 in association with the movement related values of the laser head 12 (Step S102). Based on information accumulated in the accumulator, the abnormality determination device 3 calculates the normal range of the state quantities X for each movement related value (Step S103).

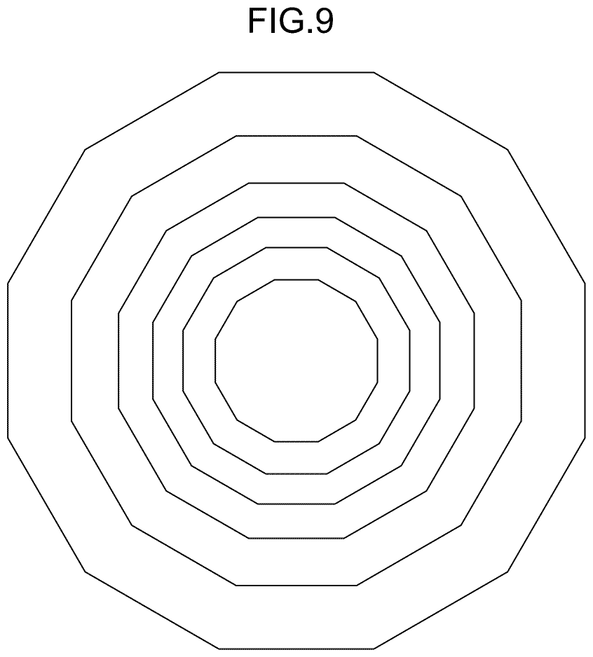

In the test machining, the laser machining tool 1 laser machines the test workpiece into a shape that is set preliminarily (hereinafter, referred to as “test machining shape”). The test machining shape is a shape that ensures a sufficient number of samples for movement speed and movement direction, which is frequently observed with shapes that are machined in actual machining. FIG. 9 is a first example of the test machining shape. For example, as shown in FIG. 9, the laser machining tool 1 performs laser machining for a first shape, consisting of multiple nested regular dodecagons, as the test machining shape while moving the laser head. The laser machining tool 1 may change the maximum speed of the laser head 12 for each regular dodecagon. The first shape allows to generate the state quantities X in each movement direction at 30° intervals with an equal number of samples.

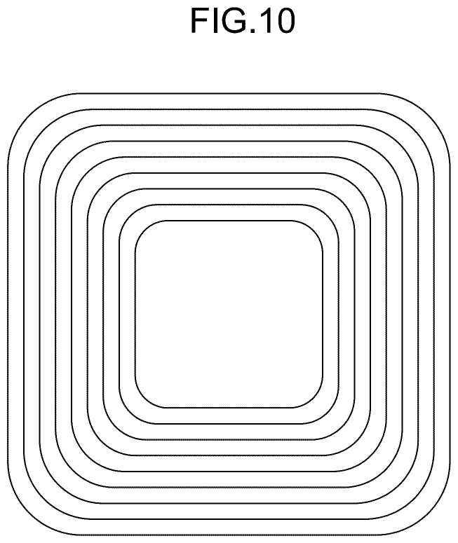

FIG. 10 is a second example of the test machining shape. For example, as shown in FIG. 10, the laser machining tool 1 performs laser machining for a second shape, consisting of multiple nested regular tetragons, as the test machining shape while moving the laser head. For example, the laser machining tool 1 changes the maximum speed of the laser head 12 for each tetragon, and machines the corners of the tetragon into rounded shapes. The second shape enables the accumulation of larger sets of data for the state quantities X1 when the movement direction is each of 0°, 90°, 180°, and 270° where the test machining shape is restricted to a rectangular shape. Also, in the second shape, since the corners of the tetragon are machined into rounded shapes, it is possible to accumulate the state quantities X1 in movement directions other than 0°, 90°, 180°, and 270°.

The processes from Step S101 to Step S103 are performed before the actual machining is performed. After these processes are completed, the actual machining is performed (Step S104). After the processes from Step S101 to Step S103 have been performed once, the actual machining described below may be performed for a certain period of time (in some instances, several months or more) without performing Step S101 to Step S103 again, as long as the machining target (material or shape of workpiece) does not change. When the actual machining is performed, the abnormality determination device 3 performs abnormality determination to determine whether or not there is a machining abnormality (Step S105). For example, the abnormality determination device 3 acquires a movement related value and a state quantity X2 during the actual machining. Then, the abnormality determination device 3 selects the normal range associated with the acquired movement related value from the normal ranges calculated for the movement related values, respectively, in Step S103. The abnormality determination device 3 then determines whether or not the state quantity X2 falls within the selected normal range, and if the state quantity X2 falls within the normal range, determines a machining abnormality as having occurred. The abnormality determination device 3 determines a machining abnormality as having occurred, for example, when a state quantity X2 falls outside the normal range once or multiple times.

If no machining abnormality is determined in Step S105, the abnormality determination device 3 determines whether or not the actual machining has been completed (Step S106). If the actual machining has not been completed, the abnormality determination device 3 transitions to Step S105 again.

If the determiner 43 determines a machining abnormality in Step S105, the outputter 44 outputs the determination result to, for example, a display device (Step S107). With such a configuration, the outputter 44 notifies the user of a machining abnormality. If no machining abnormality is determined, the outputter 44 may or may not output the determination result. If a machining abnormality is determined in Step S105, the abnormality determination device 3 may communicate with the head control device 15 to stop the actual machining. For example, if a machining abnormality is determined in Step S105, the abnormality determination device 3 transmits to the head control device 15 a machining abnormality signal indicating the determination of the abnormality. When a machining abnormality signal is received, the head control device 15 may stop the machining of the workpiece. However, the method is not limited to this example, and when a machining abnormality signal is received, the head control device 105 may execute feedback control such as reducing the movement speed during the actual machining, rather than stopping the machining of the workpiece. As an example, when a machining abnormality signal is received, the head control device 15 may change the movement speed of the laser head 12 until the state quantity X detected by a sensor such as the sensor 30 falls within the normal range. In other words, the head control device 15 may change the movement speed of the laser head 12 until the state quantity detected by the sensor falls within the normal range if the determiner 43 determines the state quantity X detected by the sensor as being outside the normal range. With such a configuration, if an abnormality occurs in machining being performed on the workpiece W, the laser machining tool 1 can address the abnormality without stopping the machining of the workpiece W.

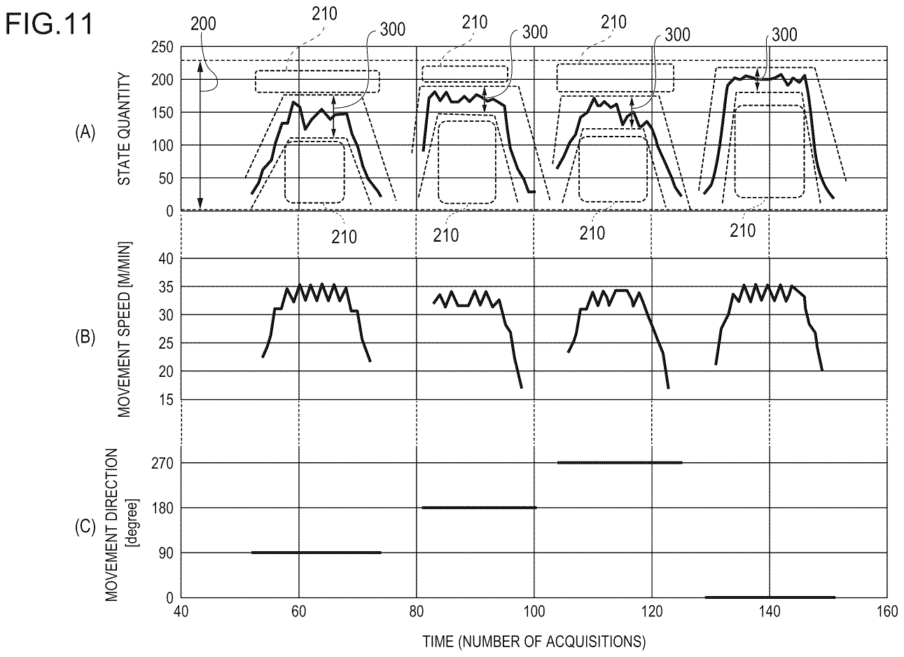

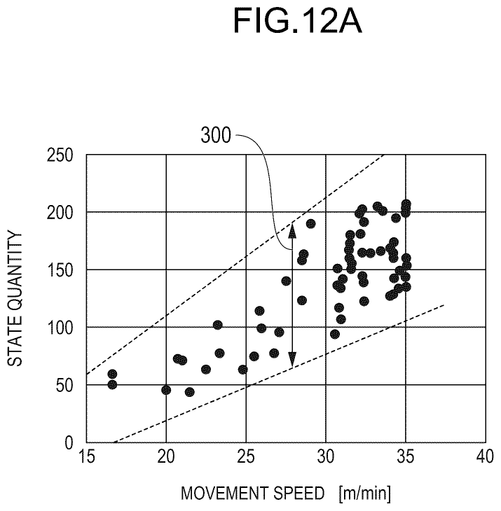

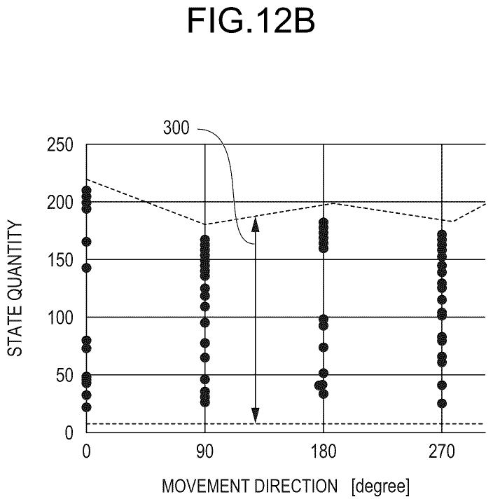

Hereinafter, the effects and advantages related to this disclosure will be described. FIG. 11 is a diagram showing a problem with abnormality determination in a laser machining tool according to a comparative example. FIG. 12 is a diagram showing relationships between the state quantities obtained in normal laser machining and both movement speeds and movement directions. Part (A) of FIG. 11 shows the state quantities obtained during normal laser machining, and parts (B) and (C) of FIG. 11 show the movement speeds and movement directions of the laser head during that time.

I found that, as shown in FIGS. 11 and 12, the possible values of the state quantities X during normal operation may vary depending on movement related values such as the movement speeds and movement directions of the laser head 12. Factors that may contribute to this include variations in heat transfer, the influence of the heat already stored in the workpiece, the shape of the laser beam, misalignment of the beam, and the directionality of the sensor 30 itself. Conventional abnormality determination does not take into account the differences in the state quantities X caused by movement related values such as the movement speeds and movement directions of the laser head 12. Also, to reduce the occurrence of “false determinations” where a machining abnormality is falsely determined despite normal machining, a broad range 200, as shown in part (A) of FIG. 11, is sometimes set as the normal range.

The range 200 is a fixed range regardless of the movement related values. Therefore, a range 210, which is a part of the range 200, may be outside the range of the state quantities X obtained during normal laser machining, and if a state quantity X is within the range 210, there is a possibility that a machining abnormality has occurred. If the normal range is set to the range 200 as mentioned above, it is possible that a machining abnormality may not be detected even if a machining abnormality has occurred. The abnormality determination device 3 sets ranges taking into account the movement related values, that is, ranges 300 that vary depending on the movement related values, as the normal ranges. Such a configuration enables the determination of a machining abnormality when a state quantity X within the range 210 is detected, allowing for more accurate determination of a machining abnormality in the workpiece W.

The state quantities X detected by a sensor such as the sensor 30 are directly transmitted to the abnormality determination device 3. However, the method is not limited to this configuration, and the state quantities X detected by the sensor may be transmitted to the head control device 15. The state quantities X are transmitted from the head control device 15 to the abnormality determination device 3.

The abnormality determination device 3 acquires the movement related values from the head control device 15. However, the method is not limited to this configuration, and the abnormality determination device 3 (for example, the acquirer 40) may acquire position information of the laser head 12 from the head control device 15 or the laser head 12, and based on the acquired position information of the laser head 12, calculate the movement related values. Also, the abnormality determination device 3 may, in parallel, acquire the movement related values from the head control device 15 and based on the position information of the laser head 12, calculate the movement related values on. The acquirer 40 of the abnormality determination device 3 may use either the movement related values acquired from the head control device 15 or the movement related values calculated by itself, or may newly find the average value of both values as the movement related value.

In the example described above, an example was given in which the normal ranges of the state quantities X for movement related values, respectively, are set as the table 100. However, the method is not limited to example, and for example, based on the information accumulated in the accumulator 41, the calculator 42 may calculate the normal range of the state quantities X for each movement related value as an arithmetic expression. When representing the normal range as an arithmetic expression, for example, Equation (3) to Equation (5) below can be considered.

$$X min \leq X \leq X max \qquad ( 3 )$$

$$X max ( v , θ ) = {a}_{0} {V}^{2} + {a}_{1} V + {a}_{2} + {b}_{0} sin ( {b}_{1} θ + {b}_{2} ) \qquad ( 4 )$$

$$X min ( v , θ ) = {c}_{0} {V}^{2} + {c}_{1} V + {c}_{2} + {d}_{0} sin ( {d}_{1} θ + {d}_{2} ) \qquad ( 5 )$$

Xmin represents the minimum value of the state quantities X among its normal values, while Xmax represents the maximum value of the state quantities X among its normal values. v represents the movement speed of the laser head 12, and θ represents the movement direction of the laser head 12. aₙ, bₙ, cₙ, and dₙ (where n ranges from 1 to 3) are constants that may be set depending on the machining target, the machining condition, and the type of the state quantities X.

In the above example, an example has been described in which based on the average value and standard deviation acquired from the normal range calculation table, the calculator 42 calculates a range between the upper limit value shown in Equation (1) and the lower limit value shown in Equation (2) as the normal range; however, the method is not limited to this example. For example, based on the average value acquired from the normal range calculation table, the calculator 42 may calculate a range between the upper limit value shown in Equation (6) and the lower limit value shown in Equation (7) as the normal range. However, the method is not limited to this configuration, and the calculator 42 may calculate a range below the upper limit value shown in Equation (6) as the normal range, or may calculate a range above the lower limit value shown in Equation (7) as the normal range. The fixed values shown below may be set preliminarily based on information accumulated in the accumulator 41.

$$Upper limit value = average value + fixed value \qquad ( 6 )$$

$$Lower limit value = average value - fixed value \qquad ( 7 )$$

In the above example, the determiner 43 may take into account the rate of change of the state quantities X during abnormality determination, and may determine a machining abnormality if the rate of change of the state quantities X2 deviates from a reference value. For example, the state quantities X2 are assumed to be acquired at a constant cycle T, and the state quantity X2 at time t is represented as X(t). The rate of change in the state quantity X2 is either or both of the rate of change ΔX(t) in the state quantity X2 per unit time and the rate of change Δ′X (t) in the state quantity X per movement distance. The rate of change ΔX(t) is expressed by Equation (8) below, and the rate of change Δ′X(t) is expressed by Equation (9) below.

$$ΔX ( t ) = ( X ( t ) - Δ X ( t - T ) ) / T \qquad ( 8 )$$

$${ΔX}^{′} ( t ) = ( X ( t ) - Δ X ( t - T ) ) / ( v ( t ) \cdot T ) \qquad ( 9 )$$

The determiner 43 may calculate the rate of change ΔX(t) during actual machining, and determine a machining abnormality if this rate of change ΔX(t) exceeds the upper limit value. The determiner 43 may determine a machining abnormality if the rate of change ΔX(t) falls below the lower limit value. The determiner 43 may also determine a machining abnormality if the rate of change ΔX(t) falls outside the range between the upper limit value and the lower limit value.

Also, the determiner 43 may calculate the rate of change Δ′X(t) during actual machining, and determine a machining abnormality if this rate of change Δ′X(t) exceeds the upper limit value. The determiner 43 may determine a machining abnormality if the rate of change Δ′X(t) falls below the lower limit value. The determiner 43 may also determine a machining abnormality if the rate of change Δ′X(t) falls outside the range between the upper limit value and the lower limit value.

When the rate of change in the state quantity X is used to perform abnormality determination, the upper limit value and lower limit value of the rate of change in the state quantity X may be calculated based on the information accumulated in the accumulator 41. In other words, based on the information accumulated in the accumulator 41, the calculator 42 may calculate the upper limit value and the lower limit value of the rate of change in the state quantity X for each movement related value as the normal range of the state quantities X. The upper limit value and the lower limit value of the rate of change in the state quantity X may be set in a table or by an arithmetic expression. The upper limit value and the lower limit value of the rate of change mentioned above may be changeable depending on the machining target workpiece W and the machining conditions.

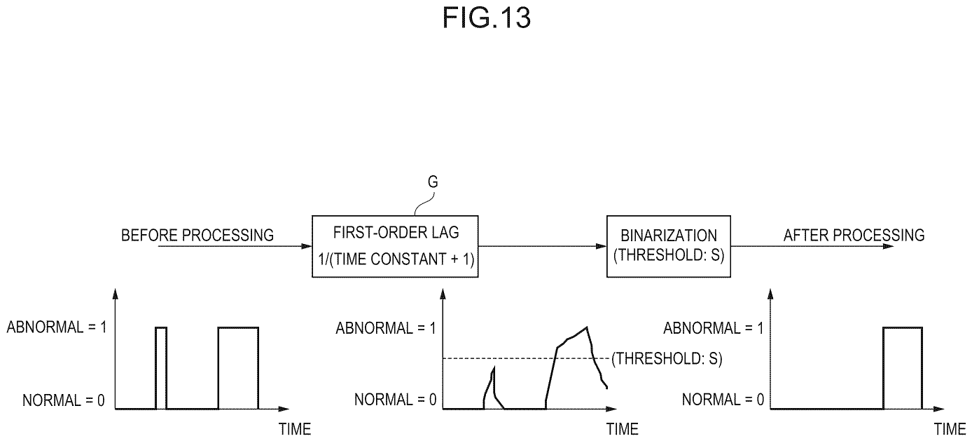

In the abnormality determination in the above example, a transfer function G may be provided that can take into account the continuity of deviations of the state quantity from the normal range. FIG. 13 is a diagram showing the transfer function G. The determiner 43 may treat the determination of normality or abnormality as a continuous quantity between 0 and 1 and use the transfer function G, such as a first-order lag transfer function, to thereby determine whether or not a machining abnormality is present. For example, the determiner 43 may assign “0” to normal and “1” to abnormal, inputting the values indicating whether the state quantity X2 is normal or abnormal at each constant cycle into the transfer function G, such as a first-order lag transfer function. Then, only when the value output from the transfer function G exceeds a threshold value S, the determiner 43 determines a machining abnormality. This configuration allows for the determination of only a prolonged continuous abnormality. The threshold value S may be changeable depending on the machining target workpiece W and the machining conditions.

In the above example, when the state quantities X include multiple sensor values, the calculator 42 may calculate a normal range of the state quantities X for each movement related value (for example, a table 100, an arithmetic expression, and so forth) for each sensor value. The determiner 43 may individually perform an abnormality determination for each sensor value. The determiner 43 may determine a machining abnormality if even one of the determination results for each sensor value is detected as deviating from the normal range, that is, if an abnormal sensor value is detected. However, the method is not limited to this configuration, and for example, an upper limit may be set on the number of allowable abnormal sensor values, and if the number of detected abnormal sensor values exceeds this limit, a machining abnormality may be determined. Also, the determiner 43 may apply a weight to the abnormality determination of each sensor value and generate a combined score. Then, the determiner 43 may determine a machining abnormality if the score exceeds a predetermined value. This predetermined value may be changeable depending on the machining target workpiece W and the machining conditions.

When the state quantities X include multiple sensor values, the determiner 43 may correlate the behaviors of the multiple sensor values to generate state quantities X3 that serve as a new determination index, and perform an abnormality determination on the generated state quantities X3. The calculator 42 calculates the normal range of the state quantities X3 for each movement related value using methods such as the table 100 and the arithmetic expressions exemplified in Equation (3) to Equation (5).

In the above example, where the abnormality determination device 3 is applied to the laser machining tool 1 has been described as an example. However, the device to which the abnormality determination device 3 can be applied is not limited to the laser machining tool 1, and it can also be applied to devices such as a plotter that uses numerical control (NC) to draw pictures, a skiving machine that performs skiving machining, or a machining center.

### SUPPLEMENTARY NOTE

The above example discloses at least the following configurations.

### Configuration 1

An abnormality determination device that determines a machining abnormality of a workpiece in a machining device having a mover that moves relative to a workpiece, and a processor that is provided on the mover and performs machining on the workpiece while moving together with the mover relative to the workpiece, the abnormality determination device comprising a sensor that detects state quantities related to machining of the workpiece performed by the machining device, an acquirer that acquires movement related values related to a movement of the mover, an accumulator that accumulates, when the processor performs normal machining on the workpiece while moving relative to the workpiece as the mover moves, the state quantities detected by the sensor in association with the movement related values acquired by the acquirer, a calculator that calculates, based on information accumulated in the accumulator, a normal range of the state quantities for each movement related value, and a determiner that determines, based on a calculation result of the calculator, whether or not a state quantity detected by the sensor is within the normal range when, after the normal range is calculated, the processor performs machining on the workpiece while moving relative to the workpiece as the mover moves.

### Configuration 2

The abnormality determination device according to configuration 1, wherein the movement related values include movement speeds of the mover.

### Configuration 3

The abnormality determination device according to configuration 1 or 2,
wherein the movement related values include movement directions of the mover.

### Configuration 4

The abnormality determination device according to any one of configurations 1 to 3, wherein the machining device is a laser machining tool and the mover is a laser head included in the laser machining tool, and wherein the processor is a laser emitter of the laser head that emits a laser beam.

### Configuration 5

The abnormality determination device according to any one of configurations 1 to 4, wherein based on information accumulated in the accumulator, the calculator calculates a table indicating the normal range for each movement related value, and wherein based on the table, the determiner determines whether or not the state quantity detected by the sensor is within the normal range.

### Configuration 6

The abnormality determination device according to any one of configurations 1 to 5, wherein the calculator derives, based on information accumulated in the accumulator, an arithmetic expression for calculating the normal range for each movement relate value, and wherein based on the arithmetic expression, the determiner determines whether or not the state quantity detected by the sensor is within the normal range.

### Configuration 7

The abnormality determination device according to any one of configurations 1 to 6, wherein the sensor detects, as a state quantity, at least one of a quantity of light, a temperature, a sound, and an image analysis result.

### Configuration 8

A laser machining tool comprising a laser head that moves relative to a workpiece, a laser emitter that is provided in the laser head and emits a laser beam onto the workpiece to perform machining on the workpiece while moving together with the laser head relative to the workpiece, and the abnormality determination device according to any one of configurations 1 to 7.

### Configuration 9

The laser machining tool according to configuration 8, comprising a head control device that stops machining of the workpiece if the determiner determines the state quantity detected by the sensor as being outside the normal range.

### Configuration 10

The laser machining tool according to configuration 8, comprising a head control device that changes a movement speed of the laser head until the state quantity detected by the sensor falls within the normal range if the determiner determines the state quantity detected by the sensor as being outside the normal range.

The device, tool and method have been described above. However, the technical scope of this disclosure is not limited to the description of the above example. It is also apparent to those skilled in the art that various modifications or improvements can be added to the above example. It is also apparent from the scope of claims that this disclosure also encompasses one or more of such modifications or improvements. One or more of the requirements described in the above example may be omitted in some instances. One or more of the requirements described in the above example may be combined where appropriate. The order of executing procedures shown in this disclosure can be implemented in an arbitrary order unless the result of the previous procedure is used in the following procedure. While operations in the above example have been described with expressions such as “first”, “next”, and “subsequently” for the sake of convenience, the operations need not always be implemented in that order. The contents of Japanese Patent Application No. 2022-113303 and all documents cited in the detailed description herein are incorporated herein by reference to the extent permitted by law.

1. An abnormality determination device that determines a machining abnormality of a workpiece in a machining device having a mover that moves relative to a workpiece, and a processor that is provided on the mover and performs machining on the workpiece while moving together with the mover relative to the workpiece,
the abnormality determination device comprising
a sensor that is provided on the mover and detects state quantities related to machining of the workpiece performed by the machining device while moving together with the mover relative to the workpiece,
an acquirer that acquires movement related values related to a movement of the mover,
an accumulator that accumulates, when the processor performs normal machining on the workpiece while moving relative to the workpiece as the mover moves, the state quantities detected by the sensor in association with the movement related values acquired by the acquirer,
a calculator that calculates, based on information accumulated in the accumulator, a normal range of the state quantities for each movement related value, and
a determiner that determines, based on a calculation result of the calculator, whether or not a state quantity detected by the sensor is within the normal range when, after the normal range is calculated, the processor performs machining on the workpiece while moving relative to the workpiece as the mover moves.

2. The abnormality determination device according to claim 1,
wherein the movement related values include movement speeds of the mover.

3. The abnormality determination device according to claim 1,
wherein the movement related values include movement directions of the mover.

4. The abnormality determination device according to claim 1,
wherein the machining device is a laser machining tool;
wherein the mover is a laser head included in the laser machining tool, and
wherein the processor is a laser emitter of the laser head that emits a laser beam.

5. The abnormality determination device according to claim 1,
wherein based on information accumulated in the accumulator, the calculator calculates a table indicating the normal range for each movement related value, and
wherein based on the table, the determiner determines whether or not the state quantity detected by the sensor is within the normal range.

6. The abnormality determination device according to claim 1,
wherein the calculator derives, based on information accumulated in the accumulator, an arithmetic expression for calculating the normal range for each movement related value, and
wherein based on the arithmetic expression, the determiner determines whether or not the state quantity detected by the sensor is within the normal range.

7. The abnormality determination device according to claim 1,
wherein the sensor detects, as a state quantity, at least one of a quantity of light, a temperature, a sound, and an image analysis result.

8. A laser machining tool comprising
a laser head that moves relative to a workpiece, a laser emitter that is provided in the laser head and emits a laser beam onto the workpiece to perform machining on the workpiece while moving together with the laser head relative to the workpiece, and an abnormality determination device that determines a machining abnormality of the workpiece,
wherein the abnormality determination device includes
a sensor that is provided in the laser head and detects state quantities of the laser machining tool while moving together with the laser head relative to the workpiece,
an acquirer that acquires movement related values related to a movement of the laser head,
an accumulator that accumulates, when the laser emitter performs normal machining on the workpiece while moving relative to the workpiece as the laser head moves, the state quantities detected by the sensor in association with the movement related values acquired by the acquirer,
a calculator that calculates, based on information accumulated in the accumulator, a normal range of the state quantities for each movement related value, and
a determiner that determines, based on a calculation result of the calculator, whether or not a state quantity detected by the sensor is within the normal range when, after the normal range is calculated, the laser head performs machining on the workpiece while moving relative to the workpiece.

9. The laser machining tool according to claim 8, comprising
a head control device that stops machining of the workpiece if the determiner determines the state quantity detected by the sensor as being outside the normal range.

10. The laser machining tool according to claim 8, comprising
a head control device that changes a movement speed of the laser head until the state quantity detected by the sensor falls within the normal range if the determiner determines the state quantity detected by the sensor as being outside the normal range.

11. An abnormality determination method for determining a machining abnormality of a workpiece in a machining device having a mover that moves relative to a workpiece, and a processor that is provided on the mover and performs machining on the workpiece while moving together with the mover relative to the workpiece,
the method comprising
detecting, when the processor performs normal machining on the workpiece while moving relative to the workpiece as the mover moves, the state quantities of machining device by the sensor that moves together with the mover relative to the workpiece,
acquiring movement related values related to a movement of the mover,
accumulating the state quantities detected by the sensor in association with the movement related values acquired by the acquirer,
calculating, based on information accumulated in the accumulator, a normal range of the state quantities by a calculator for each movement related value, and
determining, based on a calculation result of the calculator, whether or not the state quantity detected by the sensor is within the normal range when, after the normal range is calculated, the processor performs machining on the workpiece while moving relative to the workpiece as the mover moves.
